(19) United States
(12) Patent Application Publication
(10) Pub. No.: US 2019/0153243 A1
(43) Pub. Date: May 23, 2019

(54) 3C1B COATING, METHOD OF APPLYING THE SAME AND SUBSTRATE COATED THEREWITH

(71) Applicant: PPG COATINGS (TIANJIN) CO., LTD., Tianjin (CN)

(72) Inventors: Xinbo Niu, Tianjin (CN); Jian Cao, Tianjin (CN); Gehong Zhang, Tianjin (CN); Hong Tong, Tianjin (CN); Yan Liu, Tianjin (CN)

(73) Assignee: PPG COATINGS (TIANJIN) CO., LTD., Tianjin (CN)

(21) Appl. No.: 16/306,440

(22) PCT Filed: May 27, 2017
(86) PCT No.: PCT/CN2017/086240

§ 371 Date: Nov. 30, 2018

(30) Foreign Application Priority Data
May 31, 2016 (CN) 201610379016.7

(51) Int. Cl. C09D 5/38; B05D 7/00; C09D 5/10; B05D 7/14; C08K 9/02

(52) U.S. Cl. CPC C09D 5/38; B05D 7/572; C09D 5/103; C08K 2003/0812; C08K 9/02; B05D 2601/08; B05D 7/14

(57) ABSTRACT

Provided is a multi-layer coating system, comprising a first coating composition, a second coating composition, and a third coating composition, wherein the first coating composition comprises a polyester resin and an amino resin, the second coating composition comprises a nitro-modified acrylic resin and electro-plated aluminum powders, and the third coating composition comprises an acrylic resin and an anti-sagging resin. Also provided are a method of coating a substrate with the multi-layer coating system and the substrate coated therewith.

### FIELD OF INVENTION

The present invention relates to a 3C1B multi-layer coating system, a method of applying the 3C1B coating system and a substrate coated therewith, and in particular to a 3C1B multi-layer coating system comprising an electro-plated silvery coat, a method of applying the 3C1B coating system and a substrate coated therewith.

### BACKGROUND OF THE INVENTION

A three-coat one-bake (3C1B) process to apply a multi-layer coating to the body or parts of an automotive is usually used in the industrial paint application to save energy and increase production efficiency. The process comprises applying a first layer of a coating and flash-drying the first layer of the coating at an ambient temperature; then applying a second layer of a coating and flash-drying the second layer of the coating at an ambient temperature; and applying a third layer of a coating, wherein the three layers of coatings are applied in a wet-on-wet-on-wet manner. Such process can shorten the production time, reduce off-assembly time of final products, increase production efficiency, decrease usage of energy, and save cost.

The 3C1B coating system comprises a base coat, a color coat, and a clear coat. With an aluminum (Al) wheel hub used as the substrate, the Al wheel hub is first coated with black or grey powders and baked to dryness, on which the base coat, the color coat, and the clear coat are sequentially applied in a wet-on-wet-on-wet manner and then baked at a high temperature to dryness.

In a typical 3C1B process, a common aluminum powder paint is used as a color coat with a film thickness generally ranging from 15 to 25 μm. Aluminum powders have a thickness from about 250 to 400 nm and a particle size from about 8 to 40 μm with a rough surface. In the color coat, solvents have poor solubility and are present in a lower amount of about 40-50 wt %. Thus, the base coat and clear coat matching with the color coat only need slight anti-biting performance to prevent them from penetrating to the color coat. Moreover, aluminum powders in the color coat can achieve uniform arrangement through the orientation action of the resins therein and CAB, and would not considerably affect the color even if there is inter-layer penetration.

An electro-plated silvery coat presents a strong sparkling effect in appearance. After applying the electro-plated silvery coating, aluminum powders are flatly spread on the substrate, and most of aluminum powders in the form of flakes when reflecting light are capable of achieving specular reflection. For the 3C1B system comprising an electro-plated silvery color coat, as the electro-plated silvery color coat has a quite thin thickness, the base coat and top coat (clear coat) are prone to eroding and blending into the color coat, which would considerably affect the leveling of arrangement of aluminum powders. As a result, the coat upon application will lose the mirror effect and lead to failure of strong sparkling effect. Such a coat will not perform the function of an electro-plated silvery coat. Therefore, for the electro-plated silvery color coat, it is necessary to reduce the coats underlying and on the electro-plated silvery color coat to bite it. Moreover, the basecoat and topcoat (clear coat) should possess super-high leveling property and gloss.

The electro-plated silvery color coat typically has a film thickness from 2 to 5 μm. Solvents in the color coat are ketones and esters having strong solubility and present in a high amount of about 85-95 wt %. Furthermore, the resin participating in orientation of aluminum powders is present in a lower amount and fails to reorient the aluminum powders during leveling. Therefore, this will impart more requirements on the basecoat matching with the electro-plated silvery color coat, thereby significantly increasing difficulty in developing coatings used as a basecoat. The present invention aims to provide a 3C1B coating system that can solve the problems as described above and exhibit mirror effect presented by an electro-plated silvery coat.

### SUMMARY OF THE INVENTION

According to the present invention, a multi-layer coating system comprising a first coating composition, a second coating composition, and a third coating composition is provided, wherein the first coating composition comprises a polyester resin and an amino resin, the second coating composition comprises a nitro-modified acrylic resin and electro-plated aluminum powders, and the third coating composition comprises an acrylic resin and an anti-sagging resin.

Further according to the present invention, a process for forming a multi-layer coating system on a substrate is provided, comprising:
(1) applying a first coating composition to at least a portion of the substrate to form a base coat, and flash-drying the base coat;
(2) applying a second coating composition to at least a portion of the base coat to form a color coat, and flash-drying the color coat;
(3) applying a third coating composition to at least a portion of the color coat to form a clear coat, and flash-drying the clear coat; and
(4) baking the three coats to dryness at 140-150° C. for 15-30 minutes to form the multi-layer coating system, wherein the first coating composition comprises a polyester resin and an amino resin, the second coating composition comprises a nitro-modified acrylic resin and electro-plated aluminum powders, and the third coating composition comprises an acrylic resin and an anti-sagging resin.

Further according to the present invention, a coated substrate is provided, comprising:
(i) a substrate, and
(ii) a multi-layer coating system deposited on at least a portion of the substrate,
wherein the multi-layer coating system comprises a first coating composition comprising a polyester resin and an amino resin, a second coating composition comprising a nitro-modified acrylic resin and electro-plated aluminum powders, and a third coating composition comprising an acrylic resin and an anti-sagging resin.

### DESCRIPTION OF THE INVENTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims, are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

As used herein, the weight average molecular weight (Mw) of a polymer is determined by gel permeation chromatography using an appropriate standard such as a polystyrene standard.

As used herein, the term “acid value” (or “neutralization number” or “acid number” or “acidity”) is the mass of potassium hydroxide (KOH) in milligrams that is required to neutralize free acid in one gram of sample, expressed in an unit of mg KOH/g.

As used herein, the term “hydroxyl value” is the mass of potassium hydroxide (KOH) in milligrams that is equivalent to hydroxyl groups in one gram of sample, expressed in an unit of mg KOH/g.

As used herein, the term “epoxy equivalent weight” refers to grams of epoxy resin containing one equivalent of epoxide group, expressed in an unit of g/eq.

As used herein, the term “flash-dry (flash-drying)” means to allow the applied coatings to be exposed to an ambient environment for about 1-20 minutes.

The present invention is directed to providing a 3C1B multi-layer coating system, which comprises an electro-plated silvery color coat containing electro-plated silvery aluminum powders. It is well known in the art that there are several methods for treating aluminum powders, such as ball milling, atomizing, inert gas atomizing, and pressure water atomizing methods. Electro-plated silvery aluminum powders refer to aluminum powders fabricated by an electroplating process. In particular, the process comprises fabricating aluminum metal into a film that is quite thin by vacuum plating and forming the thin film into flakes having a particle size of 7-25 μm through a special pulverizing process. Aluminum powders fabricated by this process have a thinner thickness of 20-50 nm and a smoother surface than conventional aluminum powders. As compared to conventional aluminum powders, electro-plated silvery aluminum powders provide strong mirror effect and gloss. The coat film formed by such aluminum powders has gloss and metallic appearance similar to an electroplated coating.

Therefore, the color coat incorporating electro-plated silvery aluminum powders can achieve strong sparkling effect similar to an electroplated film, which is popular in some decorative occasions.

The 3C1B multi-layer coating system according to the present invention comprises a first coating composition as a base coat, a second coating composition as an electro-plated silvery color coat, and a third coating composition as a clear coat.

The first coating composition as the base coat should possess an excellent anti-biting property such that it is unlikely to be bitten by other coats during the wet-on-wet spray process. For such purpose, polyester resins having a super-high molecular weight and a high glass transition temperature are chosen as the main resin for the first coating composition.

Typically, polyester resins have a weight average molecular weight (Mw) in the range of 3,000-6,000. The polyester resins used in the first coating composition according to the present invention have a Mw up to 20,000. Preferably, the polyester resins have a Mw in the range of 12,000-20,000. The super-high molecular weight can decrease fluidity of the coat and thereby reduce the risk of being bitten.

The polyester resins have a glass transition temperature (Tg) preferably in the range of 85-125° C. A high Tg can ensure the coat achieves a quick surface dryness at a normal temperature. Herein, the coat formed from the first coating composition can achieve dry-to-touch after flash drying at the normal temperature for 4-5 minutes. The quick drying performance of the coat enables to prevent it from being bitten by other coats during the wet-on-wet process.

The polyester resin components used are prepared by an aliphatic polyacid and an aliphatic polyol. In particular, such polyester resins are dissolved only in aromatic hydrocarbon solvents. Other types of solvents are unable to dissolve the polyester resins, which further strengthens the anti-biting performance of the resulting coat and broadens the operation window. The polyester resins exhibit good adherence to the primer, have high gloss, and can impart excellent mirror effect to the upper electroplated layer.

The polyester resins can be present in the first coating composition in an amount of about 20-50 wt % based on the weight of the first coating composition. Such polyester resins can be commercially available and examples thereof can include, but are not limited to 205 available from GALSTAFF.

The first coating composition according to the present invention further comprises a curing agent, an amino resin, which is capable of cross-linking with the polyester resins to form a coat. The curing agent used has advantages such as good compatibility and quick reaction. Preferably, the amino resin is an n-butylated benzoguanamine resin, which exhibits excellent compatibility and quick reaction with the polyester resins as described above.

The amino resin can be present in the first coating composition in an amount of about 10-30 wt % based on the weight of the first coating composition. Such amino resin can be commercially available and examples thereof can include, but are not limited to CYMEL-615 available from Allne.

The first coating composition according to the present invention further comprises a leveling agent, preferably an acrylic leveling agent. Such leveling agent is well compatible with the system, without affecting the gloss and recoatbility property. Those of ordinary in the art will easily determine an appropriate amount of the leveling agent that can be introduced to the first coating composition upon reading the specification.

The first coating composition according to the present invention further comprises a solvent. The solvent can be one or more selected from the group consisting of toluene, xylene, trimethylbenzene, and tetramethylbenzene. The solvent can be present in the first coating composition in an amount of about 10-60 wt % based on the weight of the first coating composition.

The first coating composition according to the present invention further comprises other materials suitable for use in the coating composition, such as a colorant, an adhesion promoter, and other additives. The types of these materials are well known by those of ordinary in the art and the amount thereof for use in the coating composition will be easily determined by those of ordinary in the art as required by real applications.

The second coating composition as the electro-plated silvery color coat should possess excellent property for orienting aluminum powders. Aluminum powders after being sprayed can be quickly oriented, and exhibit strong metal texture and good interlayer adhesion in the form of film. For such purpose, the second coating composition selects a nitro-modified acrylic resin as the main resin. The resin exhibits superior orientation for aluminum powders without deteriorating the appearance thereof and can impart excellent mirror effect.

Preferably, the nitro-modified acrylic resin in the second coating composition has a Mw in the range of 8,000-15,000 and a Tg in the range of 110-135° C.

The nitro-modified acrylic resin can be present in the second coating composition in an amount of about 3-15 wt % based on the weight of the second coating composition. Such nitro-modified acrylic resin can be commercially available and examples thereof can include, but are not limited to AMORSO-782 available from FINE Chemical.

The second coating composition further comprises electro-plated silvery aluminum powders having a super-thin thickness and a small particle size. Preferably, the electro-plated silvery aluminum powders have a thickness in the range of 20-50 nm and a particle size in the range of 7-25 μm. Such aluminum powders are high gloss aluminum powders, which can provide excellent mirror effect and electro-plated silvery gloss. Moreover, aluminum powders having small particle size can ensure the hiding effect of the electro-plated silvery color coat such that it can achieve complete hiding at a thickness of 3-5 μm.

The electro-plated silvery aluminum powders can be present in the second coating composition in an amount of about 1-9 wt % based on the weight of the second coating composition. Such electroplated silvery aluminum powders can be commercially available and examples thereof can include, but are not limited to L55700 available from ECKART.

The second coating composition according to the present invention further comprises a solvent. The solvent comprises one or more selected from the group consisting of trimethylbenzene (Solvesso 100), methyl isobutyl ketone, ethyl acetate, and ethylene glycol monobutyl ether. The solvent can well dissolve the base materials in the color coat, but exhibits rather slight or no compatibility with the base coat. Moreover, the solvent can quickly evaporate and thereby reduce the corrosion and fusion to the base coat.

The solvent can be present in the second coating composition in an amount of about 70-95 wt % based on the weight of the second coating composition.

The second coating composition according to the present invention further comprises other additives suitable for use in the color coat as required, such as an adhesion promoter. Those of ordinary in the art will easily determine suitable additives and the amount thereof as required upon reading the present specification.

The third coating composition used as the clear coat should possess excellent leveling and distinctness of image (DOI), high gloss, and superior gloss retention. For this purpose, the coating composition uses an acrylic resin as the main resin in combination with an anti-sagging resin to reduce the risk of sagging of the coat.

The acrylic resin used in the third coating composition preferably has a Mw in the range of 3,000-6,000, a hydroxyl value in the range of 50-120 mg KOH/g, and an acid value in the range of 5-20 mgKOH/g.

The acrylic resin can be present in the third coating composition in an amount of about 15-50 wt % based on the weight of the third coating composition. Such acrylic resin can be commercially available and examples thereof can include, but are not limited to 770126 acrylic resin available from PPG KOREA.

The anti-sagging resin is preferably an acrylic resin. Such anti-sagging acrylic resin has a Mw in the range of 4,500-9,000, an acid value in the range of 10-20mgKOH/g, and an epoxy equivalent in the range of 25,000-40,000.

The anti-sagging resin can be present in the third coating composition in an amount of about 15-35 wt % based on the weight of the third coating composition. Such anti-sagging resin can be commercially available and examples thereof can include, but are not limited to 770123 acrylic resin available from PPG KOREA.

The third coating composition according to the present invention further comprises a curing agent. In a preferable embodiment, the curing agent is an amino resin. It is well known in the art to use aminoplast resins including phenolic plastics as the curing agent for materials comprising a hydroxyl group, a carboxylic group, and a carbamate functional group. Suitable aminoplast resins are well known by those skilled in the art. Amino resins may be prepared by a condensation reaction of formaldehyde with an amine or amide. Non-limiting examples of the amine or amide comprise melamine, urea, and benzoguanamine. Condensates with other amines or amides may be used, such as condensates from glycoluril. Other aldehydes such as acetaldehyde, crotonaldehyde, and benzaidehyde may be used, although formaldehyde is typically used.

Non-limiting examples of amino resins comprise melamine-formaldehyde, urea-formaldehyde, or benzoguanamine-formaldehyde condensates. Non-limiting examples of suitable amino resins comprise products under the trademark of CYMEL® commercially available from Cytec Industries, Inc., and products under the trademark of RESIMENE® commercially available from Solutia, Inc.

The third coating composition according to the present invention further comprises a solvent. The solvent comprises one or more selected from the group consisting of trimethylbenzene, tetramethylbenzene, n-butanol, ethylene glycol monobutyl ether acetate, diethylene glycol monobutyl ether, and propylene glycol monomethyl ether acetate. The solvent can well dissolve the clear coat system, but exhibits rather slight or no compatibility with the color coat, thereby avoiding improperly dissolving and biting the underlying coat.

The solvent can be present in the third coating composition in an amount of about 15-60 wt % based on the weight of the third coating composition.

The third coating composition according to the present invention further comprises other adjuvant components selected from one or more of a UV absorber, a leveling agent, a catalyst, an adhesion promoter, a deforming agent, a resistance modifier, and any additive known in the art that may be used in the third coating composition of the present invention. These adjuvant components when present are in an amount of up to 15 wt % based on the total weight of the third coating composition.

The present invention achieves the objective that each of relatively upper coats (comprising resins and solvent system) will not dissolve and penetrate the underlying coats thereof, thereby reducing interlayer permeation among coats, maintaining flatness of the coat film and realizing the mirror effect of the electro-plated coat by specifically selecting key resin systems for each coat while taking basic requirements of each coat into consideration.

The present invention further provides a process for forming a multi-layer coat on a substrate. The traditional processes for forming a coat comprise spraying a base coat followed by flash drying and baking to dryness, and spraying a color coat and a clear coat followed by flash drying and baking to dryness, which is known as the three-coat two-bake (3C2B) process; or flash drying and baking each coat to dryness after spraying each of the coats, which is known as the three-coat three-bake (3C3B) process. Different from the traditional processes, the process for forming a multi-layer coat on a substrate according to the present invention is a three-coat one-bake (3C1B) process, which means that each coat will be sprayed and flash dried and will not be baked until all three coats are sprayed. Said process can shorten production time, reduce off-assembly time of final products, increase production efficiency, decrease usage of energy, and save cost.

In particular, the process for forming a multi-layer coat on a substrate according to the present invention comprises: (1) applying a first coating composition to at least a portion of the substrate to form a base coat, and flash-drying the base coat; (2) applying a second coating composition to at least a portion of the base coat to form a color coat, and flash-drying the color coat; and (3) applying a third coating composition to at least a portion of the color coat to form a clear coat, and flash-drying the clear coat; and (4) baking the three coats to dryness at 140-150° C. for 15-30 minutes to form the multi-layer coat system, wherein the first coating composition comprises a polyester resin and an amino resin, the second coating composition comprises a nitro-modified acrylic resin and electro-plated silvery aluminum powders, and the third coating composition comprises an acrylic resin and an anti-sagging resin.

In particular, the first coating composition is sprayed as the base coat with a wet film thickness ranging from 30 μm to 50 μm. The resulting base coat is flash-dried at room temperature for 5-15 minutes. Next, the second coating composition is sprayed as the electro-plated silvery color coat with a wet film thickness ranging from 20 μm to 60 μm. The resulting color coat is flash-dried at room temperature for 2-10 minutes. The third coating composition is sprayed as the clear coat with a wet film thickness ranging from 65 μm to 80 μm. The resulting clear coat is flash-dried at room temperature for 5-15 minutes. The resulting three-coating system is baked at a temperature of 140-150° C. for 15-30 minutes, wherein the base coat is measured for a dry film thickness ranging from 10 μm to 20 μm, the electro-plated silvery color coat is measured for a dry film thickness ranging from 2 μm to 5 μm, and the clear coat is measured for a dry film thickness ranging from 40 μm to 45 μm.

Further according to the present invention, a coated substrate is provided, comprising: (i) a substrate, and (ii) a multi-layer coating system deposited on at least a portion of the substrate, wherein the multi-layer coating system comprises a first coating composition comprising a polyester resin and an amino resin, a second coating composition comprising a nitro-modified acrylic resin and electro-plated aluminum powders, and a third coating composition comprising an acrylic resin and an anti-sagging resin.

The substrate preferably comprises an aluminum alloy one. More preferably, the substrate comprises an aluminum hub.

### EXAMPLES

The following examples are presented to demonstrate the general principles of the invention. The invention should not be considered as limited to the specific examples presented. All parts and percentages in the examples are by weight unless otherwise indicated.

The first coating composition as the base coat was prepared from the components and amounts listed in Table 1.

TABLE 1
Formulation of the first coating composition

| | Example 1 | Example 2 | Example 3 |
|---|---|---|---|
| Components | (wt %*) | (wt %) | (wt %) |
| Polyester resin | 38.5 | 43.5 | 33.5 |
| Amino resin | 15 | 20 | 10 |
| Leveling agent | 1 | 1 | 1 |
| solvent | 30 | 15 | 40 |
| Adhesion promoter | 0.5 | 0.5 | 0.5 |
| Colorant paste | 15 | 15 | 15 |

*based on the total weight of the first coating composition (g):
Polyester resin: GALSTAFF 205, Tg 85-125° C., supplied by GALSTAFF;
Amino resin: CYMEL-615, supplied by Zhanxin;
Leveling agent, BYK-358N, supplied by BYK;
Adhesion promoter: ADHERANT 1121, supplied by DEUCHEM;
Solvent: xylene, trimethylbenzene, and tetramethylbenzene;
Colorant paste: JET BLACK TINTER, supplied by PPG.

The second coating composition as the electro-plated silvery color coat was prepared from the components and amounts listed in Table 2.

TABLE 2
Formulation of the second coating composition

| | Example 4 | Example 5 | Example 6 |
|---|---|---|---|
| Components | (wt %*) | (wt %) | (wt %) |
| Resin | 10 | 3 | 6 |
| Aluminum powders | 5 | 3 | 9 |
| Adhesion promoter | 1 | 1 | 1 |
| solvent | 84 | 93 | 84 |

* based on the total weight of the second coating composition (g):
Resin: acrylic resin AMPRSO-782, supplied by AMPRSO;
Aluminum powders: L55700, supplied by ECKART;
Adhesion promoter: ADHERANT 1121, supplied by DEUCHEM CO LTD;
Solvent: a mixture of trimethylbenzene, methyl isobutyl ketone, ethyl acetate, and ethylene glycol monobutyl ether.

The third coating composition as the clear coat was prepared from the components and amounts listed in Table 3.

TABLE 3
Formulation of the third coating composition

| | Example 7 | Example 8 | Example 9 |
|---|---|---|---|
| Components | (wt %*) | (wt %) | (wt %) |
| Resin-1 | 29.5 | 24.5 | 19.5 |
| Curing agent | 15 | 15 | 20 |
| catalyst | 0.5 | 0.5 | 0.5 |
| Resin-2 | 20 | 25 | 25 |
| Adhesion promoter | 3 | 3 | 3 |
| Deforming agent | 0.5 | 0.5 | 0.5 |
| UV absorber | 3 | 3 | 3 |
| Leveling agent-1 | 1 | 1 | 1 |
| Leveling agent-2 | 0.5 | 0.5 | 0.5 |
| Conductive adjuvant | 2 | 2 | 2 |
| solvent | 25 | 25 | 25 |

*based on the total weight of the third coating composition (g):
Resin-1: acrylic resin, supplied by PPG KOREA;
Curing agent: amino resin SETAMINE US 138 BB70, supplied by Nuplex;
Catalyst: CYCAT VXK 6395 CATALYST (effectively reducing film-forming temperature), supplied by ALLNEX;
Resin-2: anti-sagging acrylic resin770.123 HYDROXYLATED ACRYLIC, supplied by PPG;
Adhesion promoter: ADHERANT 1121, supplied by DEUCHEM;
Deforming agent: BYK-066N, supplied by BYK;
UV absorber: TINUVIN 400, supplied by BASF;
Leveling agent-1: BYK-358N, supplied by BYK;
Leveling agent-2: BYK-306, supplied by BYK;
Conductive adjuvant: TEXQUART 879-B-LSG (adjusting conductivity of the coating in order to match rotary cup spraying process), PPG US;
Solvent: a mixture of SHELLSOL A150, n-butanol, diethylene glycol monobutyl ether, and trimethylbenzene, supplied by PPG.

### Testing Results

According to the 3C1B process of the present invention, the three coating compositions were applied to an aluminum alloy substrate, comprising: spraying the first coating composition (Examples 1-3), flash-drying and leveling the coating composition; spraying the second coating composition (Examples 4-6), flash-drying and leveling the coating composition; spraying the first coating composition (Examples 7-9), thereby producing a sample of the aluminum alloy substrate coated with the three-coat system of the present invention (Examples 10-12).

The resulting three-coat system was tested for properties. The tested properties comprises an adhesion testing, a high humidity testing, a salt spray resistance testing, a CASS testing, and a paint film appearance testing.

### 1. Adhesion Testing

A “X” sign was cut on the sample, where vertically crossing lines extended to the substrate. A 3M8898 tape was adhered to the surface of the sample and pressed firmly with a rubber to allow the tape sufficiently to contact the testing surface. After holding for 5-10 seconds, the tape was quickly torn off. The testing surface was visually inspected and adhesion no less than 99% or evaluated as Rating 0 is required.

### 2. High Humidity Testing

The sample was placed in a GTJ-T-043 humidity chamber under conditions: 96 h@38° C., ˜100% RH; and 240 h@38° C., ˜100% RH, and appearance was inspected. The sample was taken from the humidity chamber after 120 hours with moisture removed. The sampel was examined for adhesion after recovering one hour with the same tesing method as in 1.

### 3. Salt Spray Resistance Testing

The sample was scored according to GMW15282. Then the scored sample was placed in a GTJ-T-042 salt spray cabinet at 35° C., and evacuated at 336 hours and 1000 hours. It is required that the corrosion at the incision and edges thereof be less than 1 mm. No adhesion was lost after air blowing and no appearance change was observed.

### 4. CASS Testing

The sample was scored according to GMW15282. Then the scored sample was placed in a card box at 49° C. The sample was evaluated after 168 hours. It is required that the corrosion at the incision and edges thereof be less than 3 mm. No adhesion was lost after air blowing and no appearance change was observed.

### 5. Paint Film Appearance Testing

The coated sample was exposed to the sunlight to observe the orientation effect of aluminum powders and compared with a standard panel and a wet-on-dry sample to evaluate appearance.

TABLE 4
Testing results for properties

| | | High | Salt Spray | | |
|---|---|---|---|---|---|
| | Adhesion | Humidity | Resistance | | Paint Film |
| | Testing | Testing | Testing | CASS Testing | Appearance Testing |
| Example | Pass, | No | No appearance | No appearance | Good paint film |
| 10 | peeling | appearance | change, | change, | appearance, |
| | area less | change, | corrosion at | corrosion at | aluminum |
| | than 1% | peeling | incision and | incision and | orientation identical |
| | | area less | edge less than | edge less than | to standard, same as |
| | | than 1% | 1 mm, no | 3 mm, no | wet-on-dry result |
| | | | adhesion loss | adhesion loss | |
| | | | | after air | |
| | | | | blowing | |
| Example | Pass, | No | No appearance | No appearance | Good paint film |
| 11 | peeling | appearance | change, | change, | appearance, |
| | area less | change, | corrosion at | corrosion at | aluminum |
| | than 1% | peeling | incision and | incision and | orientation identical |
| | | area less | edge less than | edge less than | to standard, same as |
| | | than 1% | 1 mm, no | 3 mm, no | wet-on-dry result |
| | | | adhesion loss | adhesion loss | |
| | | | | after air | |
| | | | | blowing | |
| Example | Pass, | No | No appearance | No appearance | Good paint film |
| 12 | peeling | appearance | change, | change, | appearance, |
| | area less | change, | corrosion at | corrosion at | aluminum |
| | than 1% | peeling | incision and | incision and | orientation identical |
| | | area less | edge less than | edge less than | to standard, same as |
| | | than 1% | 1 mm, no | 3 mm, no | wet-on-dry result |
| | | | adhesion loss | adhesion loss | |
| | | | | after air | |
| | | | | blowing | |

Although particular aspects of this invention have been explained and described above, it will be evident to those skilled in the art that numerous variations and modifications to the present invention may be made without departing from the scope and spirit of the present invention. Therefore, the appended claims are intended to encompass these variations and modifications falling within the present invention.

1. A multi-layer coating system, comprising a first coating composition, a second coating composition, and a third coating composition, wherein the first coating composition comprises a polyester resin and an amino resin, the second coating composition comprises a nitro-modified acrylic resin and electro-plated aluminum powders, and the third coating composition comprises an acrylic resin and an anti-sagging resin.

2. The multi-layer coating system according to claim 1, wherein the polyester resin in the first coating composition has a Mw in the range of 12,000-20,000 and a Tg in the range of 85-125° C.

3. The multi-layer coating system according to claim 1, wherein the polyester resin in the first coating composition is only dissolved in an aromatic hydrocarbon solvent.

4. The multi-layer coating system according to claim 1, wherein the amino resin in the first coating composition is an n-butylated benzoguanamine resin.

5. The multi-layer coating system according to claim 1, wherein the nitro-modified acrylic resin in the second coating composition has a Mw in the range of 8,000-15,000 and a Tg in the range of 110-135° C.

6. The multi-layer coating system according to claim 1, wherein the electro-plated aluminum powders in the second coating composition have a thickness in the range of 20-50 nm and a particle size in the range of 7-25 μm.

7. The multi-layer coating system according to claim 1, wherein the acrylic resin in the third coating composition has a Mw in the range of 3,000-6,000, a hydroxyl value in the range of 50-120 mg KOH/g, and an acid value in the range of 5-20 mgKOH/g.

8. The multi-layer coating system according to claim 1, wherein the anti-sagging resin in the third coating composition is an anti-sagging acrylic resin that has a Mw in the range of 4,500-9,000, an acid value in the range of 10-20 mgKOH/g, and an epoxy equivalent in the range of 25,000-40,000.

9. A process for forming a multi-layer coating system on a substrate, comprising:
(1) applying a first coating composition to at least a portion of the substrate to form a base coat, and flash-drying the base coat;
(2) applying a second coating composition to at least a portion of the base coat to form a color coat, and flash-drying the color coat; and
(3) applying a third coating composition to at least a portion of the color coat to form a clear coat, and flash-drying the color coat,
the three coats are baked to dryness at 140-150° C. for 15-30 minutes to form the multi-layer coating system,
wherein the first coating composition comprises a polyester resin and an amino resin, the second coating composition comprises a nitro-modified acrylic resin and electro-plated aluminum powders, and the third coating composition comprises an acrylic resin and an anti-sagging resin.

10. A coated substrate, comprising:
(i) a substrate, and
(ii) a multi-layer coating system deposited on at least a portion of the substrate,
wherein the first coating composition comprises a first coating composition comprising a polyester resin and an amino resin, a second coating composition comprising a nitro-modified acrylic resin and electro-plated aluminum powders, and a third coating composition comprising an acrylic resin and an anti-sagging resin.

11. The coated substrate according to claim 10, wherein the substrate is an aluminum hub.
